(19) United States
(12) Patent Application Publication
(10) Pub. No.: US 2020/0003969 A1
(43) Pub. Date: Jan. 2, 2020

(54) OPTICAL BRANCH MODULE

(71) Applicant: KITANIHON ELECTRIC CABLE CO., LTD., Sendai-shi, Miyagi (JP)

(72) Inventors: Yuto YAMASHITA, Shibata-gun, Miyagi (JP); Takayuki KIKUCHI, Shibata-gun, Miyagi (JP); Fumiyasu SATOU, Shibata-gun, Miyagi (JP); Hidetomo NISHIMURA, Shibata-gun, Miyagi (JP)

(21) Appl. No.: 16/072,718

(22) PCT Filed: Jan. 10, 2018
(86) PCT No.: PCT/JP2018/000308

§ 371 Date: Jul. 25, 2018

(30) Foreign Application Priority Data
Mar. 21, 2017 (JP) 2017-054090

(51) Int. Cl. G02B 6/42; G02B 6/32; G02B 6/28; G02B 6/293

(52) U.S. Cl. CPC G02B 6/4214; G02B 6/32; G02B 6/293; G02B 6/4206; G02B 6/2817

(57) ABSTRACT

An optical branch module including a glass block, an input/output gradient index lens, an output gradient index lens, a beam splitter film, a mirror film, an input optical fiber, a first output optical fiber that extracts input light from the input optical fiber reflected by the beam splitter film as first output light, and a second output optical fiber that extracts light passed through the beam splitter film passed through the glass block, reflected by the mirror film, passed through the glass block again, and input from the other end of the output gradient index lens as second output light.

### BACKGROUND

### 1. Field of the Disclosure

The present disclosure relates to an optical branch module.

### 2. Discussion of the Background Art

An optical coupler for branching or coupling light has been proposed (for example, refer to Patent Literature 1). The optical coupler in Patent Document 1 melts and extends an optical fiber to form an optical coupling portion. In addition, there is an optical coupler using a quartz waveguide.

In both of the fiber and the quartz waveguide, an input optical fiber and an output optical fiber are arranged along a through direction on the single line. Therefore, it is necessary to arrange a module and the optical coupler that are arranged in front of and behind the optical coupler on a straight line.

### CITATION LIST

### Patent Literature

### Patent Literature 1: JP 2007-121478 A

As a size of an optical module has been reduced, efficient arrangement of an optical coupler and various modules in a package has been desired. Therefore, an object of the present disclosure is to relax restriction on arrangement caused by an optical coupler.

### SUMMARY

An optical branch module according to the present disclosure includes:

a glass block configured to transmit light;

an input/output gradient index lens arranged at one end of the glass block and having a length of a quarter of a period of input light;

an output gradient index lens arranged at one end of the glass block and having a length of a quarter of a period of input light;

a beam splitter film arranged between the other end of the input/output gradient index lens and one end of the glass block and configured to transmit and reflect light at a constant rate;

a mirror film arranged at the other end of the glass block and configured to reflect light;

an input optical fiber connected to one end of the input/output gradient index lens and configured to input input light to the input/output gradient index lens;

a first output optical fiber connected to a position, where the input light from the input optical fiber is converged after being reflected by the beam splitter film, at one end of the input/output gradient index lens and configured to extract the reflected light as first output light; and

a second output optical fiber connected to a position, where the light passed through the beam splitter film is converged after passing through the glass block, reflected by the mirror film, passing through the glass block again, and input from the other end of the output gradient index lens, at one end of the output gradient index lens and configured to extract the input light as second output light.

According to the present disclosure, since restriction on arrangement caused an optical coupler is relaxed, various modules can be efficiently arranged in a package.

### BRIEF DESCRIPTION OF THE DRAWINGS

FIG. 1 is a configuration example of an optical branch module according to a first embodiment.

FIG. 2 is an example of a cross section on a first output optical fiber.

FIG. 3 is an example of a cross section on a second output optical fiber.

FIG. 4 is an exemplary application to three or more branches.

FIG. 5 is a configuration example of an optical branch module according to a second embodiment.

FIG. 6 is a first configuration example of an optical branch module according to a third embodiment.

FIG. 7 is a second configuration example of the optical branch module according to the third embodiment.

FIG. 8 is a first configuration example of an optical branch module according to a fourth embodiment.

FIG. 9 is a second configuration example of the optical branch module according to the fourth embodiment.

FIG. 10 is a configuration example of an optical branch module according to a fifth embodiment.

FIG. 11 is a configuration example of an optical branch module according to a sixth embodiment.

### DETAILED DESCRIPTION OF THE PREFERRED EMBODIMENT

Hereinafter, embodiments of the present disclosure will be described in detail with reference to the drawings. It should be noted that the present disclosure is not limited to the embodiments described below. These embodiments are merely examples, and the present disclosure can be implemented in various modified and improved forms based on knowledge of those skilled in the art. Note that it is assumed that components denoted with the same reference numerals in the specification and the drawings indicate the same component.

(Basic Structure)

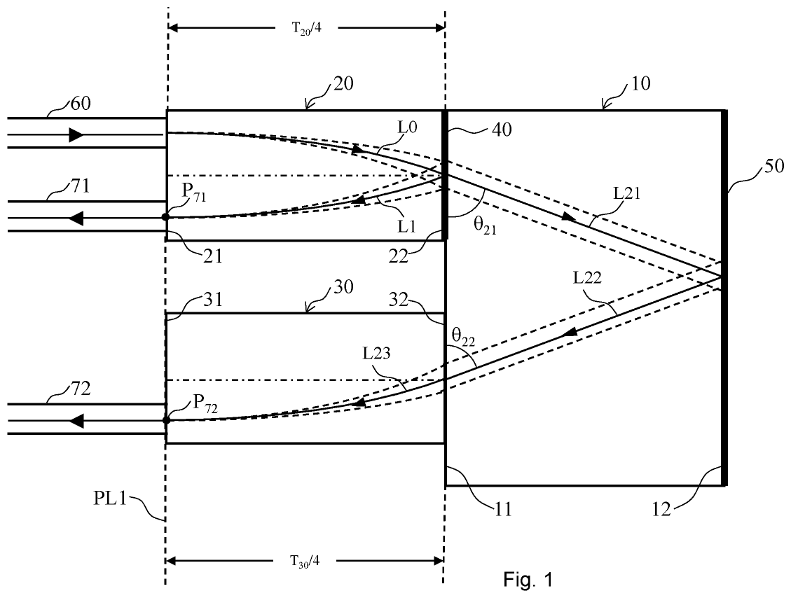

In FIG. 1, a configuration example of an optical branch module is illustrated. The optical branch module includes a glass block 10, a Graded Index (GI) lens 20 that functions as an input/output gradient index lens, a GI lens 30 that functions as an output gradient index lens, a beam splitter film 40, a mirror film 50, an optical fiber 60 that functions as an input optical fiber, an optical fiber 71 that functions as a first output optical fiber, and an optical fiber 72 that functions as a second output optical fiber.

An optical fiber group including the optical fibers 60, 71, and 72 is arranged on a side of an end surface 11 of the glass block 10. Specifically, the GI lens 20 is arranged on the end surface 11 positioned at one end of the glass block 10. The GI lens 30 is arranged on the end surface 11 positioned at one end of the glass block 10. The beam splitter film 40 is arranged between an end surface 22 positioned at the other end of the GI lens 20 and the end surface 11 positioned at the one end of the glass block 10. The mirror film 50 is arranged on the end surface 12 positioned at the other end of the glass block 10. The optical fiber 60 is connected to an end surface 21 positioned at one end of the GI lens 20. The optical fiber 71 is connected to the end surface 21 positioned at the one end of the GI lens 20. The optical fiber 72 is connected to an end surface 31 positioned at one end of the GI lens 30.

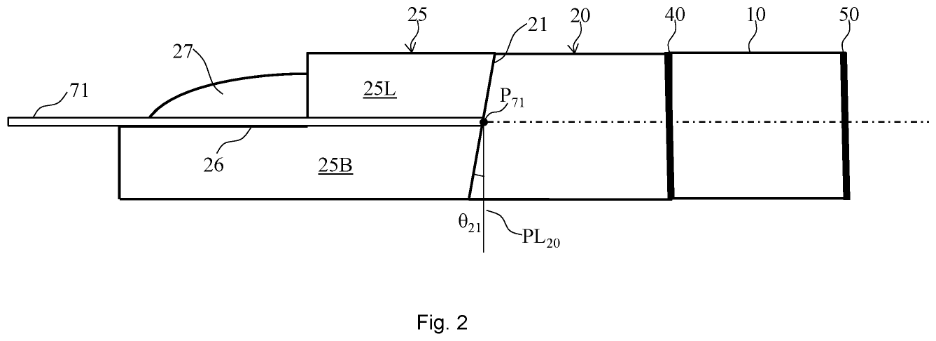

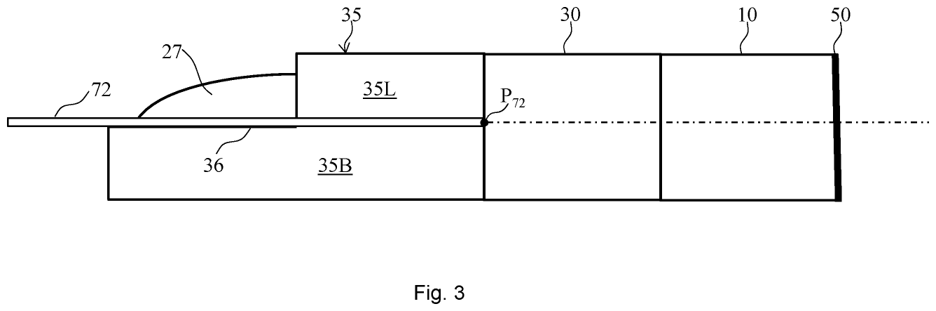

In FIGS. 2 and 3, examples of cross sections on the optical fibers 71 and 72 are illustrated. The optical fibers 71 and 72 are respectively held by glass blocks 25 and 35. The glass block 25 fixes an end surface of the optical fiber 71 to a focal point P₇₁, for example, by using a V-groove plate 25B and a lid 25L and protects the optical fiber 71. The glass block 25 has a terrace 26, and the optical fiber 71 is fixed to the terrace 26 with an adhesive 27. The glass block 35 can have the same configuration as the glass block 25. The glass blocks 25 and 35 may be capillaries. The end surface 21 is inclined at an angle θ₂₁ with respect to a surface PL₂₀ orthogonal to a central axis of the GI lens 20. With this inclination, it is possible to prevent end-surface reflection of the optical fiber 71.

The beam splitter film 40 is an arbitrary film that transmits and reflects light at a constant rate and is formed of a multilayer film of SiO₂ and Ta₂O₅, for example. The beam splitter film 40 may be a metal thin film. The beam splitter film 40 may be formed on the end surface 21 of the GI lens 20 and may be formed on the end surface 11 of the glass block 10. A glass plate on which the beam splitter film 40 is formed may be attached to the end surface 22 of the GI lens 20 or one end of the glass block 10 so that the beam splitter film 40 is positioned on the side of the GI lens 20.

The mirror film 50 is an arbitrary film that reflects light and is formed of a multilayer film of SiO₂ and Ta₂O₅, for example. The mirror film 50 may be a metal thin film. The mirror film 50 may be formed on the other end 12 of the glass block 10, and a glass plate on which the mirror film 50 is formed may be attached to the other end 12 of the glass block 10.

The optical fibers 60, 71 and 72 are arbitrary optical fibers. These optical fibers may be polarization maintaining optical fibers. In a case of FIG. 1, it is preferable that a polarization plane be perpendicular to a plane of paper. Furthermore, a connection surface between the optical fibers 60 and 71 and the GI lens 20 may be inclined at an angle of eight degrees. A connection surface between the optical fiber 72 and the GI lens 30 may be inclined at an angle of eight degrees.

(Optical Path)

In FIG. 1, each of alternate long and short dash lines in the GI lenses 20 and 30 represents a central axis of the lens. Dashed lines in the GI lenses 20 and 30 and the glass block 10 represent beams, and an arrow represent a beam center.

The optical fiber 60 inputs light L0 to the end surface 21 of the GI lens 20. When the light L0 propagates through the GI lens 20 in a period T₂₀, the GI lens 20 has a length of a quarter of the period T₂₀. The light L0 input from the optical fiber 60 to the GI lens 20 becomes parallel light at the end surface 22 of the GI lens 20. The beam splitter film 40 transmits and reflects the light L0 at a constant rate. The constant rate is an arbitrary ratio determined according to the number of branches of the optical branch module.

Light L1 reflected by the beam splitter film 40 is converged on the end surface 21 of the GI lens 20. The optical fiber 71 is connected to a position of the focal point P₇₁ where the light L0 from the optical fiber 60 is converged after being reflected by the beam splitter film 40. The optical fiber 71 extracts the light L1 as first output light.

Parallel light L21 passed through the beam splitter film 40 passes through the glass block 10 and is reflected by the mirror film 50. Reflected parallel light L22 passes through the glass block 10 again and is input to an end surface 32 of the GI lens 30. When light L23 propagates through the GI lens 30 in a period T₃₀, the GI lens 30 has a length of a quarter of the period T₃₀. The light L23 input from the glass block 10 to the GI lens 30 is converged on the end surface 31 of the GI lens 30. The optical fiber 72 is connected to a position of a focal point P₇₂ where light L23 input from the glass block 10 to the GI lens 30 is converged. The optical fiber 72 extracts the light L23 as second output light.

As described above, in the present disclosure, the light L0 is input from the optical fiber 60, the Light L1 is extracted from the optical fiber 71, and the light L23 is extracted from the optical fiber 72. With this structure, in the present disclosure, a module connected to the optical fiber group including the optical fibers 60, 71, and 72 can be arranged on the side of the end surface 11 of the glass block 10. According to the above, the present disclosure can relax restriction on arrangement caused an optical coupler and efficiently arrange various modules in a package.

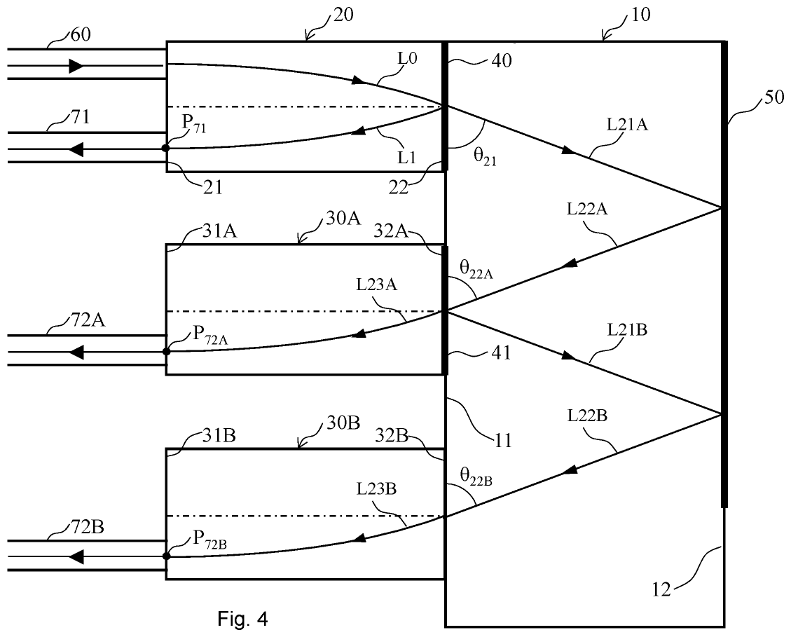

Although the number of branches in FIG. 1 is two, the present disclosure can be applied to three or more branches. For example, as illustrated in FIG. 4, two GI lenses 30A and 30B and two optical fibers 72A and 72B are included, and a beam splitter film 41 that transmits and reflects light at a constant rate is provided on an end surface 32A of the GI lens 30A. By providing the beam splitter film 41 in this way, the present disclosure can be applied to any number of branches.

The branch made by the beam splitter film 40 has lower wavelength dependency than branch made by setting a coupling length, and in addition, control of a branch ratio is easier. Since the light is branched by the beam splitter film 40 in the present disclosure, the branch ratio is easily controlled, and a wavelength band can be widened depending on the function of the beam splitter film 40. Furthermore, since the optical fibers 60, 71 and 72 are arranged in the same direction, a space can be saved when the optical fibers are incorporated in a system.

Furthermore, when polarization maintaining type coupler is manufactured from among fiber-melting-type couplers, it is difficult to control stress application and it is difficult to maintain a high polarization extinction ratio because a stress body of the optical fiber is melted. On the other hand, in the present disclosure, since the parallel light L21 and L22 is reflected in the glass block 10, a polarization direction can be maintained. Therefore, only by using polarization maintaining fibers as the optical fibers 60, 71, and 72, light from the polarization maintaining fiber can be branched as maintaining the polarization direction.

### First Embodiment

FIG. 1 is a configuration example of an optical branch module according to the present embodiment. An end surface 11 of a glass block 10 is flat, and surfaces of a beam splitter film 40 and a mirror film 50 and an end surface 32 of a GI lens 30 are parallel to each other.

An incident angle θ₂₁ of light L21 to the glass block 10 is equal to an output angle θ₂₂ of light L22 from the glass block 10. Furthermore, apertures and lengths of the GI lenses 20 and 30 are equal to each other. Therefore, by making light L23 enter the center of the end surface 32 of the GI lens 30, the light L23 can be condensed at the focal point P₇₂ on the end surface 31.

In the present embodiment, by symmetrically designing optical paths of the light L0 and the light L23, a common optical material can be used for the GI lenses 20 and 30. In addition, since the optical fibers 60, 71, and 72 are arranged in parallel to a common plane PL1, the optical fibers can be easily handled.

### Second Embodiment

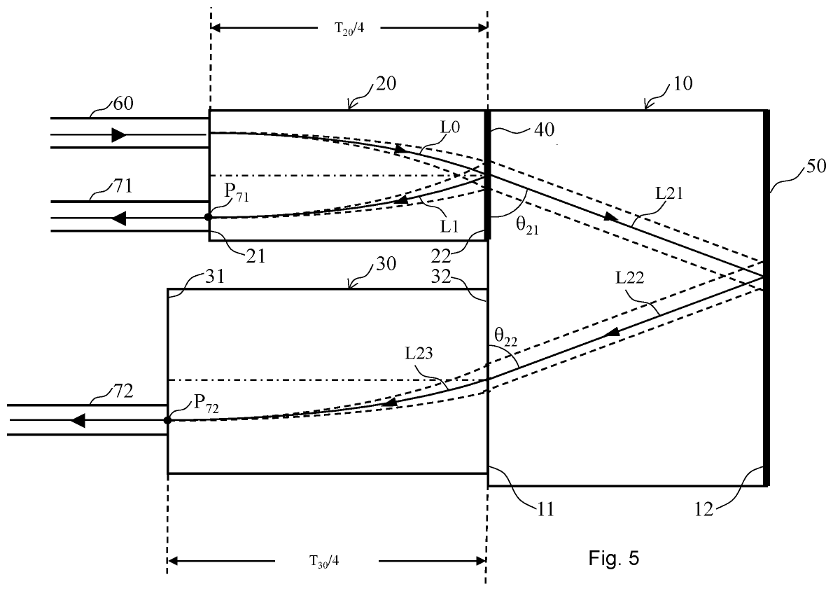

FIG. 5 is a configuration example of an optical branch module according to the present embodiment. In the present embodiment, an aperture of a GI lens 30 is larger than an aperture of a GI lens 20 in the first embodiment. During propagation in a glass block 10, a beam diameter may be increased. Even in such a case, light can be efficiently condensed on an optical fiber 72.

A refractive index distribution of the GI lens 30 may be the same as or different from that of the GI lens 20. In this case, it is preferable that the GI lens 30 has a length that converges light L23 incident from an end surface 32 at a focal point P₇₂ on an end surface 31. For example, it is preferable that the GI lens 30 be longer than the GI lens 20.

### Third Embodiment

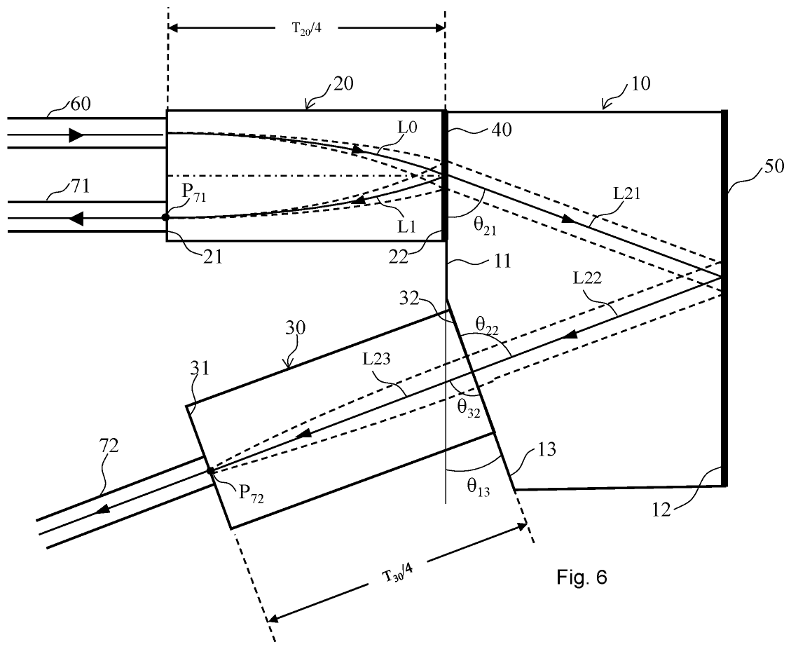

FIG. 6 is a configuration example of an optical branch module according to the present embodiment. An inclined surface 13 is provided on an end surface 11 of a glass block 10, and a GI lens 30 is connected to the inclined surface 13.

An angle θ₁₃ of the inclined surface 13 with respect to the end surface 11 is an angle with which the inclined surface 13 substantially matches a plane orthogonal to a beam center of parallel light L22. An angle θ₂₂ of the inclined surface 13 with respect to the beam center of the parallel light L22 is approximately 90 degrees, and an angle θ₃₂ of an end surface 32 with respect to a central axis of the GI lens 30 is approximately 90 degrees. With this angle, the central axis of the GI lens 30 is arranged on the same straight line as the beam center of the parallel light L22, and an optical fiber 72 is connected to the center of the GI lens 30.

In the present embodiment, since the vicinity of the center of the GI lens 30 is used as an optical path of light L23, the light L23 can be accurately condensed. Accordingly, the present disclosure can improve a coupling efficiency to the optical fiber 72.

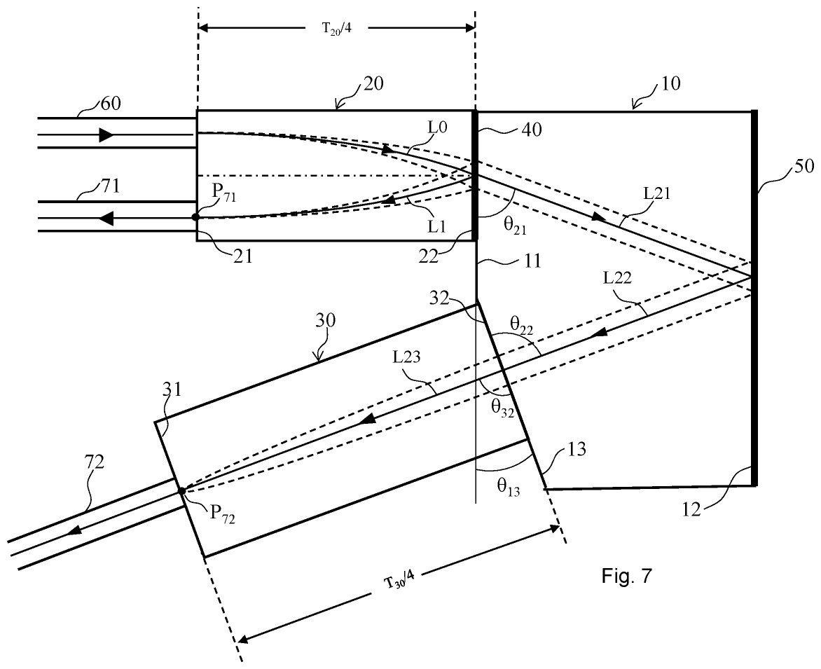

To prevent end-surface reflection, it is preferable that the angles θ₂₂ and θ₃₂ be within 90°±8 except 90 degrees. Furthermore, in the optical branch module according to the present embodiment, an aperture of the GI lens 30 may be larger than an aperture of the GI lens 20 as illustrated in FIG. 7.

### Fourth Embodiment

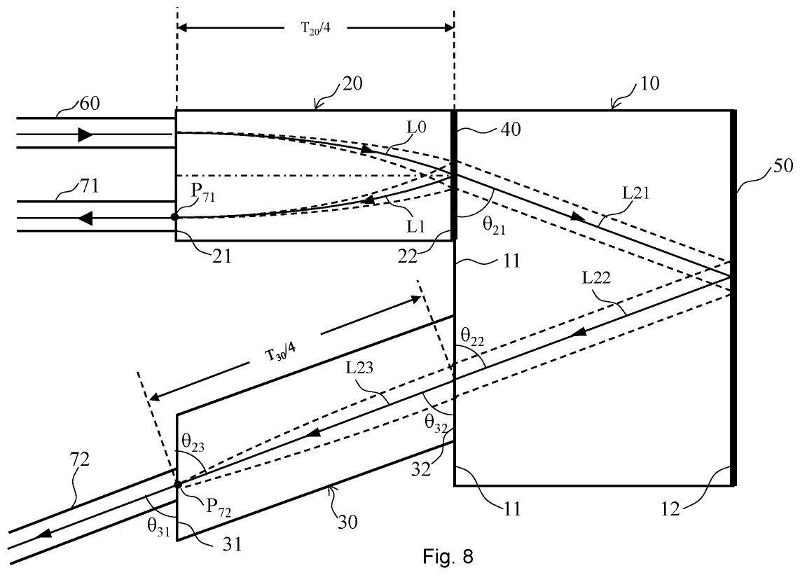

FIG. 8 is a configuration example of an optical branch module according to the present embodiment. End surfaces 31 and 32 of a GI lens 30 are inclined with respect to a plane orthogonal to a central axis of the GI lens 30.

An angle θ₂₃ of the end surface 31 with respect to the central axis of the GI lens 30 is equal to an angle θ₂₂ of an end surface 11 with respect to a beam center of parallel light L23, and an angle θ₃₂ of an end surface 32 with respect to the central axis of the GI lens 30 is equal to an angle θ₂₂ of the end surface 11 with respect to a beam center of parallel light L22. With this angle, the central axis of the GI lens 30 is arranged on the same straight line as the beam center of the parallel light L22, and an optical fiber 72 is connected to the center of the GI lens 30.

In the present embodiment, since the vicinity of the center of the GI lens 30 is used as an optical path of light L23, the light L23 can be accurately condensed. Accordingly, the present disclosure can improve a coupling efficiency to the optical fiber 72.

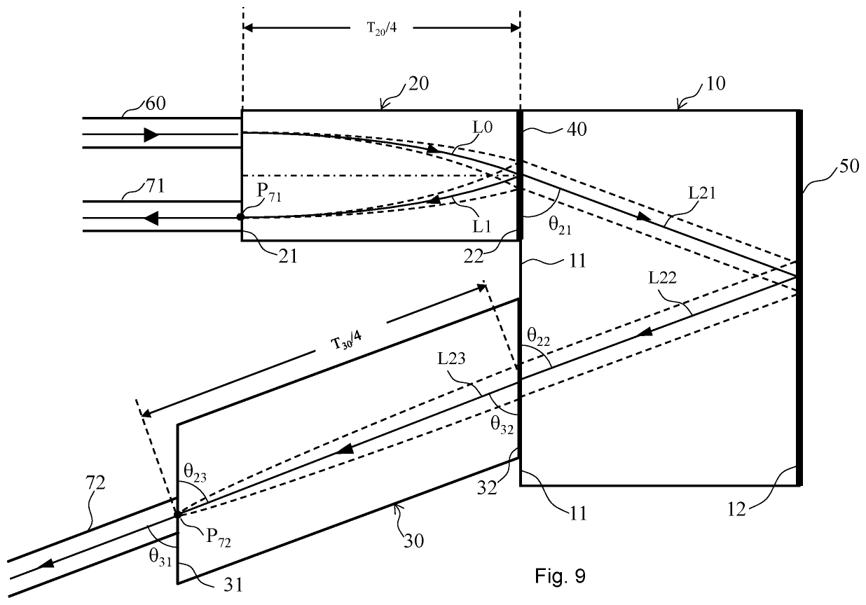

To prevent end-surface reflection, it is preferable that the angles θ₂₂ and θ₃₂ be within 90°±8 except 90 degrees. Furthermore, in the optical branch module according to the present embodiment, an aperture of the GI lens 30 may be larger than an aperture of the GI lens 20 as illustrated in FIG. 9.

### Fifth Embodiment

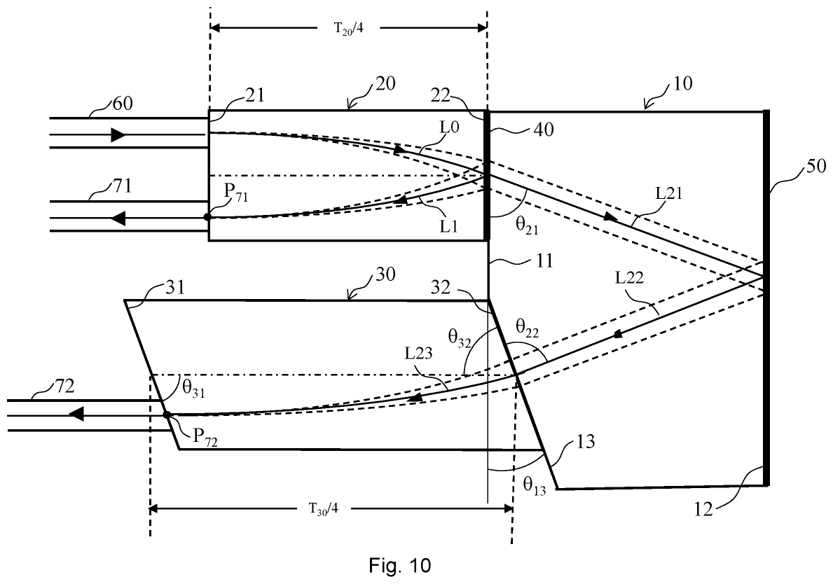

FIG. 10 is a configuration example of an optical branch module according to the present embodiment. An inclined surface 13 is provided on an end surface 11 of a glass block 10 at an angle θ₁₃, and a GI lens 30 is connected to the inclined surface 13. The end surface 32 is inclined with respect to the central axis of the GI lens 30 at an angle θ₃₂.

The central axis of the GI lens 30 is not arranged on the same straight line as a beam center of parallel light L22. Therefore, an optical fiber 72 is connected to a position separated from the center of the GI lens 30.

A surface of a beam splitter film 40 and a surface of a mirror film 50 are parallel to each other. The sum of the angles θ₁₃ and θ₃₂ is 90°. Therefore, the central axes of the GI lenses 20 and 30 can be arranged in parallel. Since the three optical fibers 60, 71, and 72 can be arranged in parallel, a space can be saved.

To prevent end-surface reflection, it is preferable that the angle θ₃₂ be within 90°±8 except 90 degrees. Furthermore, it is preferable that an angle θ₃₁ of an end surface 31 with respect to the central axis of the GI lens 30 be equal to an angle θ₃₂, that is, the end surfaces 31 and 32 and the inclined surface 13 be parallel to each other. It is possible to prevent end-surface reflection at an input/output end of the GI lens 30.

### Sixth Embodiment

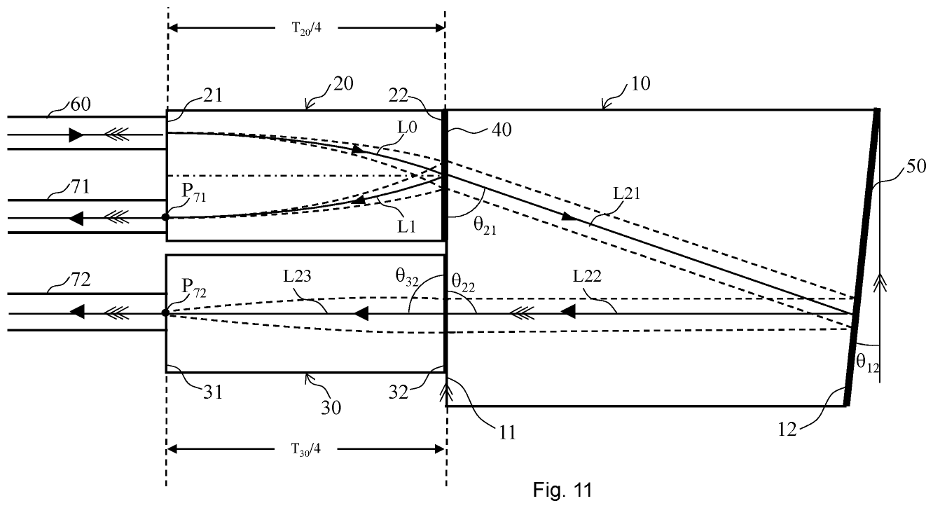

FIG. 11 is a configuration example of an optical branch module according to the present embodiment. In FIG. 11, “<<<” attached to light L22 and optical fibers 60, 71, and 72 indicates that those components are arranged in parallel, and “<<” attached to an end surface 11 and an auxiliary line of an angle auxiliary line θ₁₂ indicates that these components are arranged in parallel. An end surface 12 of a glass block 10 is inclined so that the parallel light L22 is parallel to the optical fibers 60 and 71. The optical fiber 72 is connected to the center of a GI lens 30.

The central axis of a GI lens 20 and the central axis of the GI lens 30 are parallel to each other. A surface of a mirror film 50 is inclined with respect to a surface of a beam splitter film 40 at an angle θ₁₂.

The angle θ₁₂ is a direction that makes the parallel light L22 be perpendicular to the end surface L11. With this angle, the central axis of the GI lens 30 is arranged on the same straight line as the beam center of the parallel light L22, and an optical fiber 72 is connected to the center of the GI lens 30. Furthermore, the central axes of the GI lenses 20 and 30 are arranged in parallel.

Since the three optical fibers 60, 71 and 72 can be arranged in the same direction, a space can be saved. In addition, since the vicinity of the center of the GI lens 30 is used as an optical path, light can be accurately condensed, and a coupling efficiency can be further improved.

### INDUSTRIAL APPLICABILITY

The present disclosure can be applied to an optical fiber product that needs a function to branch light in fields of optical communication and optical measurement.

### REFERENCE SIGNS LIST

10, 25, 35 glass block
11, 12, 21, 22, 31, 31A, 31B, 32 end surface
13 inclined surface
20, 30, 30A, 30B GI lens
25B, 35B V-groove plate
25L, 35L lid
26, 36 terrace
27 adhesive
40 beam splitter film
50 mirror film
60, 71, 72, 72A, 72B optical fiber

What is claimed is:

1. An optical branch module comprising:
a glass block configured to transmit light;
an input/output gradient index lens arranged at one end of the glass block and having a length of a quarter of a period of input light;
an output gradient index lens arranged at one end of the glass block and having a length of a quarter of a period of input light;
a beam splitter film arranged between the other end of the input/output gradient index lens and one end of the glass block and configured to transmit and reflect light at a constant rate;
a mirror film arranged at the other end of the glass block and configured to reflect light;
an input optical fiber connected to one end of the input/output gradient index lens and configured to input input light to the input/output gradient index lens;
a first output optical fiber connected to a position, where the input light from the input optical fiber is converged after being reflected by the beam splitter film, at one end of the input/output gradient index lens and configured to extract the reflected light as first output light; and
a second output optical fiber connected to a position, where the light passed through the beam splitter film is converged after passing through the glass block, being reflected by the mirror film, passing through the glass block again, and being input from the other end of the output gradient index lens, at one end of the output gradient index lens and configured to extract the input light as second output light.

2. The optical branch module according to claim 1, wherein
an aperture of the output gradient index lens is larger than an aperture of the input/output gradient index lens.

3. The optical branch module according to claim 2, wherein
a central axis of the output gradient index lens is positioned on the same straight line as a beam center of light from the glass block.

4. The optical branch module according to claim 3, wherein
one surface of the output gradient index lens and the other surface of the output gradient index lens are inclined with respect to a plane orthogonal to the central axis of the output gradient index lens.

5. The optical branch module according to claim 2, wherein
a surface of the beam splitter film and a surface of the mirror film are parallel to each other,
one surface of the output gradient index lens, the other surface of the output gradient index lens, and a connection surface of the glass block with the other end of the output gradient index lens are parallel to each other, and
the one surface of the output gradient index lens and the other surface of the output gradient index lens are inclined with respect to a plane orthogonal to a central axis of the output gradient index lens.

6. The optical branch module according to claim 2, wherein
a central axis of the input/output gradient index lens and a central axis of the output gradient index lens are parallel to each other, and
a surface of the mirror film is inclined with respect to a surface of the beam splitter film.

7. The optical branch module according to claim 1, wherein
a central axis of the output gradient index lens is positioned on the same straight line as a beam center of light from the glass block.

8. The optical branch module according to claim 7, wherein
one surface of the output gradient index lens and the other surface of the output gradient index lens are inclined with respect to a plane orthogonal to the central axis of the output gradient index lens.

9. The optical branch module according to claim 1, wherein
a surface of the beam splitter film and a surface of the mirror film are parallel to each other,
one surface of the output gradient index lens, the other surface of the output gradient index lens, and a connection surface of the glass block with the other end of the output gradient index lens are parallel to each other, and
the one surface of the output gradient index lens and the other surface of the output gradient index lens are inclined with respect to a plane orthogonal to a central axis of the output gradient index lens.

10. The optical branch module according to claim 1, wherein
a central axis of the input/output gradient index lens and a central axis of the output gradient index lens are parallel to each other, and
a surface of the mirror film is inclined with respect to a surface of the beam splitter film.
